(19) United States
(12) Patent Application Publication
(10) Pub. No.: US 2008/0064553 A1
(43) Pub. Date: Mar. 13, 2008

(54) Offset Drive Direct Ratio Gear Coupling

(76) Inventor: Alan Robert Newton, East Wareham, MA (US)

Correspondence Address: Alan R. Newton, 67 Bluebird Avenue, East Wareham, MA, 02538, US

(21) Appl. No.: 11/596,513

(22) PCT Filed: Jun. 3, 2004
(86) PCT No.: PCT/GB05/02208

§ 371 Date: Sep. 5, 2007

(30) Foreign Application Priority Data
Jun. 8, 2004 (GB) 0412723.9
May 13, 2005 (GB) 0509781.1

(51) Int. Cl. F16H 1/32; F16D 3/04; F16H 55/08

(52) U.S. Cl. 475/165

(57) ABSTRACT

Conventional internal gear systems for example planetary gear systems with a small gear ratio of the internal gear to that of the driving pinion, problems include tooth ‘tip’ interference and limited contact between teeth, in conjunction with number of teeth in true positive contact when orbiting. An internal gear system using ring gear (14) and pinion (16) of the same number of teeth where the pitch diameters can be different. When the pinion pitch diameter is smaller than the ring gear, one element is offset to the others rotational center, maintaining constant tooth engagement, with one element transmitting torque to the other.

Conventional type ‘gear boxes’ in general could be said to fall into two main categories,
a) That of a fixed ratio type for example ratios of say 1:20, 1:50 and so on. That is, in the case of a 1:50 ratio the input shaft speed, (for example only) will revolve at say 1000 revolutions per minute (R.P.M.); and the output shaft speed would be 200 r.p.m.
b) The second category, would be that of a variable speed ‘gearbox’ whereby the input shaft would be for example ‘x’ r.p.m; and the output shaft speed would be say incrementally variable from ‘x’ r.p.m. down to say x/50 x/60 and would have a minimum output speed dependent on design status.

Hundreds of various designs have been introduced and patented since as early as the 1920's up to present day. In general the gearboxes tend to use three main principals of design,
1) worm and gear
2) planet—orbital
3) Gear trains.

All types are relatively expensive due to the precision machining necessary to satisfy the design criteria.

Also different type boxes have to be used to provide the correct ratio for the design requirements. (In the case of fixed ratio types ‘a’).

By way of the following description and drawings the invention seeks to improve on existing designs.

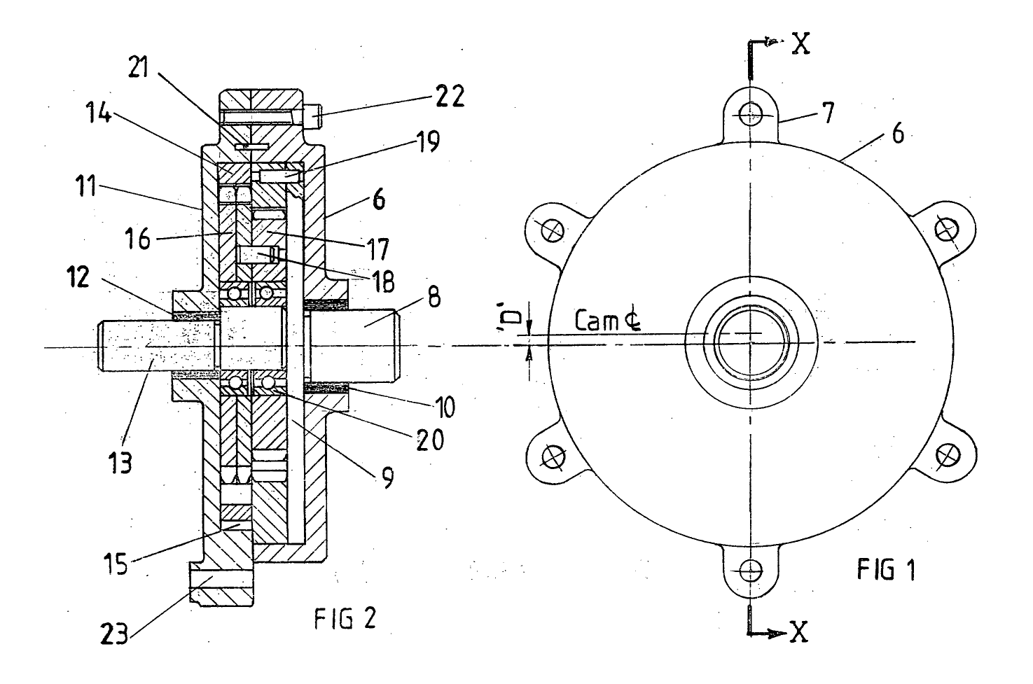

FIG. 1. Front elevation

FIG. 2. Sectional view through gear unit.

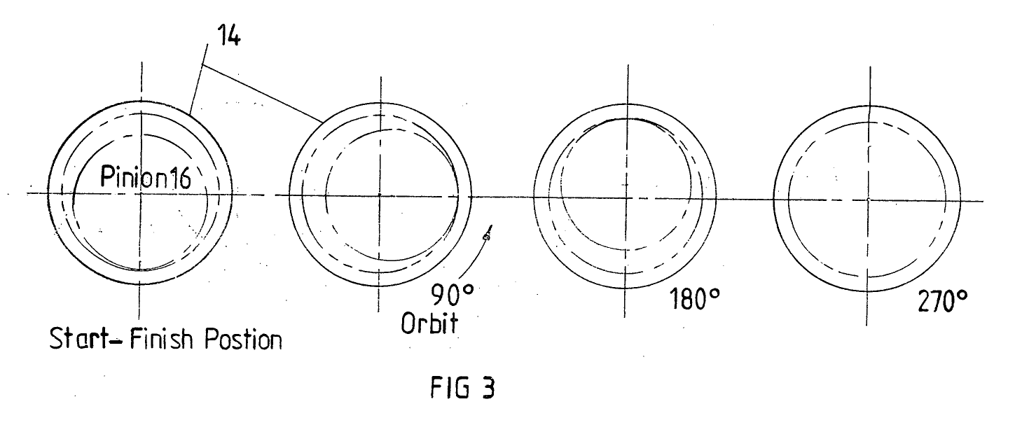

FIG. 3. Diagrammatic layouts of the ring gear and pinion.

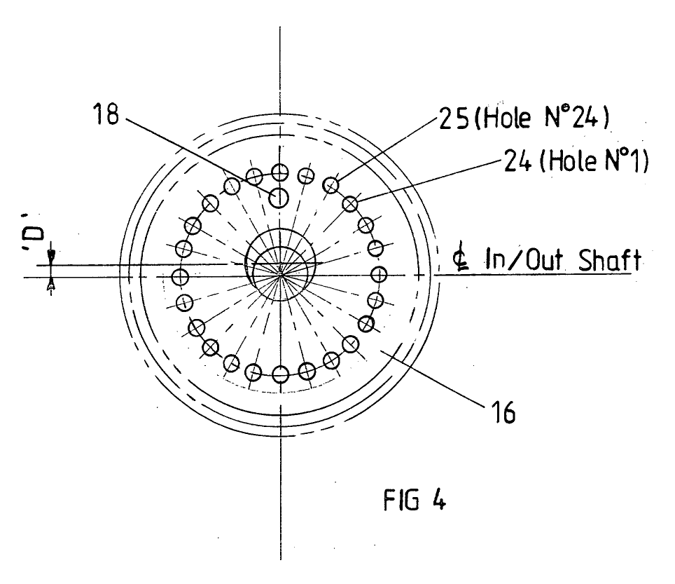

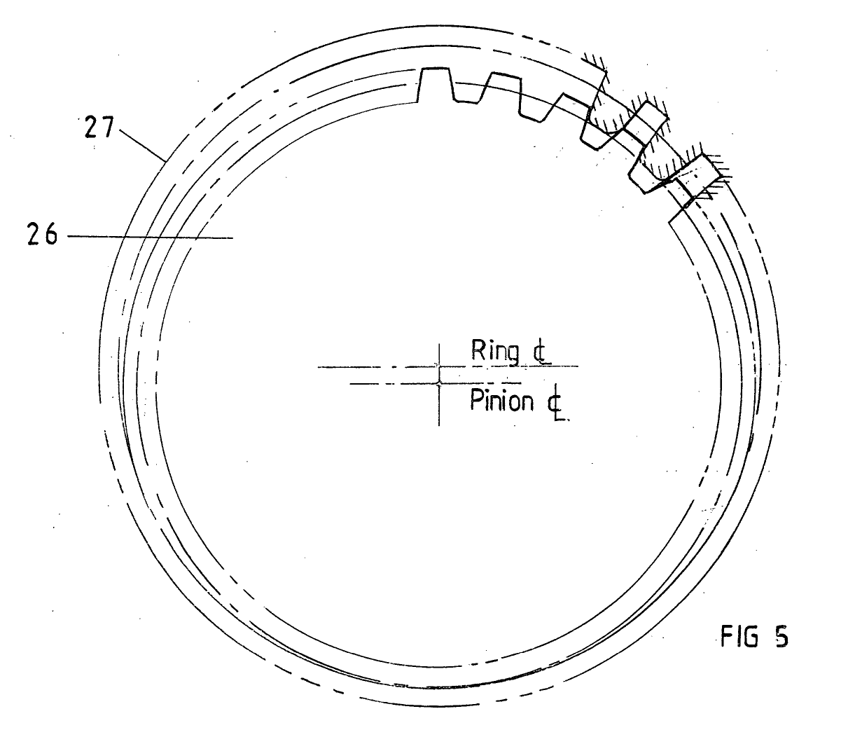

FIG. 4. Front elevation of pinions

FIG. 5. Large scale 28t ‘pinion’ and ‘ring gear’.

All parts used in the description would be manufactured to specified dimension and material specifications also heat treatment as necessary, to satisfy the design criteria.

Item 6 FIG. 1 is the outline of the right hand casing, (front) containing integral lugs item's 7 with suitable holes. Three (for this example) are for ‘cap-head’ screws 22 which hold the ‘right’ hand outer casing (or front) to the ‘left’ hand (back) casing item 11 in position using one or more locating pins item 21. The remaining three holes 22 in the lugs 7 are for mounting the ‘gear box’ in position.

The unit consists of an output shaft 8 FIG. 2, which has an integral circular flange 9, the shaft is suitably arranged within a bearing 10.

Item 13 FIG. 2 is the input shaft arranged within a bearing 12. The input shaft containing an eccentric portion at the inner part end, and is dimensionally defined by the dimension ‘D’ FIGS. 1 and 4. The requisite amount of eccentricity will be directly proportional to the speed ratio required relative to the ‘input’ and ‘output’ shafts 8 and 13. Further design detail of the importance of this will later be described.

Two bearings 20 FIG. 2 are fitted to the eccentric part of the ‘input’ shaft 13.

These bearings via their frictional fit are adequately secured within the respective bores of the ‘input’ pinion 16 FIG. 2 and the ‘output’ pinion 17. The respective number of teeth of these pinions will be directly proportional to the final speed ratio required from the unit; and will be described later in greater detail.

An input ‘ring gear’ item 14 FIG. 2 is suitably fixed to the outer casing 11 by means of a key and key way item 15.

One or more ‘dowel’ type pins 18 are used for transfer of angular rotation from the ‘input’ pinion 16 to the ‘output’ pinion 17.

A secondary ‘dowel’ 19 FIG. 2 is used to transfer rotation to the ‘output’ shaft 8 from the ‘output’ ring gear 17.

Technical data will now be described which envelopes the technical theory of the unit.

General description is that a mating set of ‘pinion’ to ‘ring gear’, both on the ‘input’ and ‘output’ sides of the unit; both as aforesaid described.

Orbiting.

FIG. 3 shows the outlines of the ‘ring gear’ item 14 with the engaging ‘pinion’ 16, firstly, that at ‘start’ position pinion 16 FIG. 3 ‘rolls’ or revolves within the ring 14.(Both having the same number of engaging ‘teeth’; hence does not rotate inversely), ring centre rolls around fixed ‘pinion’ whose centre is then orbiting about the centre line of the ‘pinion’.

The four stages shown by FIG. 3 are at 90 increments anti-clock rotation from ‘start’ to ‘finish’ positions.

Drive Rotation.

By placing the ring gear in fixed position within the unit will permit ring to rotate, simultaneously placing a bearing to allow rotation of the ‘pinion’, this will then fix the two centres in position with the teeth positively engaged (pinion/ring).

Turning the ‘ring gear’ or the ‘pinion’ will transmit rotation one to the other, since both ‘pinion’ and ‘ring gear’ have same number of teeth the ratio will be 1:1 or, ‘offset bearing transmission’.

Item 16 FIG. 4 showing outline of the outside dia, pitch circle, diameter and ‘root line’ for the laminated ‘pinion’ profiles.

The indexing holes 24 (hole no. 1) and 25 (hole no. 24) are spaced equally within the 360 P.C.D. there is in total number, twenty four holes each of equal diameter to suit and be compatible with the dowel pin 19 FIG. 2.

The indexing holes 1-24 FIG. 4 allowing locking adjustment of ‘pinion’ tooth profiles. As cam offset design is altered to accommodate the orbit of output gear sets (that is to change ratio).

Reducing the cam offset dim ‘D’ FIGS. 2 and 4 will allow backlash in non rotational orbiting set, therefore allowing laminated orbital ‘pinion’ sufficient angular movement and can therefore be selectively locked in position by at least one dowel item 18 FIGS. 2 and 4, into corresponding alignment hole. These holes are designed such that alignment can be matched according to output gear sets.

Hole number selection is matched to selected parts. Example: Ratio 29 to 1 requires cam offset dim ‘D’ FIGS. 2 and 4 to be 0.060 inches (1.52 millimetres), with ø backlash. Orbital pinion laminate half, with 0.065 inches (dim ‘D’) with corresponding dowel hole of other half.

The gearbox—as aforesaid described is a relatively high ratio gear type speed reducer, which may utilise as small as one tooth difference of ‘ring gear’ to ‘pinion’. The formula for which is noted as being the number of teeth in the driven member divided by the difference in the number of teeth of the ‘ring gear’ and ‘pinion’.

For example: 50 tooth ‘ring gear’ driven by 49 tooth ‘pinion’ has a ratio of 50 divided by “one”. Likewise, a ‘ring gear’ with 50 teeth driven by a ‘pinion’ with 48 teeth has a ratio of 50 divided by “two”. (25:1).

Further, it is anticipated that when the ‘ring gear’ is the ‘driver’ and the ‘pinion’ is the ‘driven’ member the same ratio formula will apply, with the exception that the direction of rotation is reversed between ‘driving’ and ‘driven’ members.

The cutting of the ‘ring gear’ will probably vary dependant upon machinery type, skill and expertise of both operator and manufacturing facility. One, such method is hereby described and in essence will form the basis for the necessary geometry from the ‘ring gear’ can be used to form the ‘pinion’.

FIG. 5 shows a typical part ‘pinion’ item 26 and part ‘ring gear’ outline 27. The scale used is approx. three time's full size.

Item 26 represents the ‘pinion’ which has 28 teeth at 16's diametrical pitch, with a 14½ pressure angle.

Circular pitch being 0.1963 inches. ‘Gear ring’ 27 and ‘pinion’ 26 having same number of teeth.

Utilising the ‘pinion’ element as the shaping tool, (since this is a readily available tool used in existing gear shaping machines).

To form the said ‘ring gear’ FIG. 5 item 27 a blank for ‘ring gear’ is formed with an array of teeth which are substantially mated to fit the profile of the ‘pinion’ which is the shaper tool.

When commencing to form the ‘ring gear’ by actuating the form tool it is noted that as the ‘ring gear’ pitch diameter is increased.

Said increased of pressure angle is a function of geometry necessary and natural to maintain rolling contact with the ‘pinion’ tooth form. Also it is anticipated that stub tooth gear form may be utilised. Also, it is anticipated that the ‘ring gear’ can be used as geometry to form the ‘pinion’. Importantly, the geometry of the ‘pinion’ and ‘ring gear’ members are generated to mate at the pitch circles of each to the other while transmitting drive force at the offset drive centreline condition as it suits design requirements.

A description summary relating to the technical data of the invention, is as follows;

The pinion and ring gear of same number of teeth, where the pitch circle diameters can be different. When the pinion pitch diameter is smaller than the ring pitch diameter one element is offset to the others rotational centre. The object is to maintain constant tooth engagement while one element transmits torque to the other. At no time is constant tooth contact interrupted; there is rolling transmission between elements.

Full size addendum tooth form (FIG. 5), since there is no need to clear ‘tips’, as in planetary drive arrangements, involute form teeth are shown since the involute is a natural geometric form.

Finally any tooth form is acceptable providing the smooth transitional torque requirement is maintained.

1. Two elements comprising a pinion and ring gear, teeth of each element are formed to provide smooth torsional force transmission one to the other, the ring teeth pressure angle is different from the pinion due to the difference in pitch diameters, there are always at least one pair in forceable engagement between ring gear and pinion as rotational orbit takes place, transmission is smooth and transitional since they are generated as a pair-set.

2. A gear pair system according to claim 1 wherein both the ring gear and pinion are preferred form of involute.

3. A gear pair system according to claim 1 wherein any tooth form is acceptable providing the smooth transitional torque requirement is maintained.

4. A gear pair system as claimed in claims 1-3 and substantially as herein described with reference to the accompanying drawings.
